(19) United States
(12) Patent Application Publication
(10) Pub. No.: US 2006/0255715 A1
(43) Pub. Date: Nov. 16, 2006

(54) Carbon nanotube containing phosphor

(75) Inventors: Dongsheng Mao, Austin, TX (US); Richard Fink, Austin, TX (US); Zvi Yaniv, Austin, TX (US)

Correspondence Address: WINSTEAD SECHREST & MINICK P.C., PO BOX 50784, DALLAS, TX, 75201, US

(73) Assignee: Nano-Proprietary, Inc., Austin, TX (US)

(21) Appl. No.: 11/267,982

(22) Filed: Nov. 7, 2005

Related U.S. Application Data
(60) Provisional application No. 60/626,269, filed on Nov. 9, 2004.

(51) Int. Cl. H01J 63/04; H01J 1/62

(52) U.S. Cl. 313/497; 313/495; 313/485

(57) ABSTRACT

A phosphor for use in displays is a mixture of phosphors and carbon nanotubes. The phosphor screen has improved electrical and thermal conductivity.

This application claims priority to U.S. Provisional patent application Ser. No. 60/626,269.

### TECHNICAL FIELD

The present invention relates in general to phosphors, and in particular to a composite phosphor containing carbon nanotubes.

### BACKGROUND INFORMATION

Poor thermal conductivity is one of the largest problems for the deterioration of phosphor screens (see “Novel YAG Phosphor Screen for Projection CRT,” Wenbing Chen, Jianbo Cheng, and Junjian Li, Proceeding of SPIE 3954, Projection Displays 2000, Sixth in a Series, Apr. 2000, pp. 227-232). Under electron beam bombardment, the phosphor screen is easily heated up, which results in the evaporation of the phosphor, or a reaction between the phosphor and the gases (see “Synergistic Temperature and Electron Irradiation Effects on the Degradation of Cathodoluminescent ZnS:Ag, Cl Powder Phosphors,” B. L. Abrams, L. Williams, J. S. Bang, et al., Journal of the Electrochemical Society 150 (5), H105-110 (2003)). The fall off of the luminance of the phosphor degrades the quality of the picture and reduces the lifetime of the displays.

Carbon nanotubes (CNTs) have attracted much attention because of their unique physical, chemical, and mechanical properties. The large aspect ratio of CNTs together with their high chemical stability, thermal conductivity (theory value of 6000 W/m K for single wall CNTs and observation of 3000 W/m K for multiwall CNTs (see “Carbon Nanotube Composites for Thermal Management,” M. J. Biercuk, M. C. Llaguno, M. Radosavljevic et al., Applied Physics Letters 80 (15), 2767-2769 (2002))), and high electrical conductivity (0.25 m Ω cm for single wall CNTs (see “Single Wall Carbon Nanotube Fibers Extruded From Super-Acid Suspensions: Preferred Orientation, Electrical, and Thermal Transport,” W. Zhou, J. Vavro, C. Guthy et al., Applied Physics Letters 95 (2), 649-651 (2004))) are advantageous for many potential applications.

### BRIEF DESCRIPTION OF THE DRAWINGS

For a more complete understanding of the present invention, the advantages thereof, reference is now made to the following descriptions taken in conjunction with the accompanying drawings, in which:

FIG. 1 shows a schematic diagram of an electrophoretic deposition apparatus;

FIG. 2 shows a schematic diagram of a field emission diode structure;

FIG. 3 shows field emission current vs. electric field curves of three samples;

FIG. 4 shows field emission images on different phosphor screens at a current of 30 mA; and

FIG. 5 shows a luminance (Cd/m²) vs emission current of the samples.

### DETAILED DESCRIPTION

In the following description, numerous specific details are set forth such as specific network configurations, etc. to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

A phosphor mixed with CNTs may have the following advantages:
1. Greatly improved thermal conductivity of the phosphor coating, thus increasing the lifetime;
2. The black/dark color of the CNTs in the mixture improve the contrast ratio of the picture quality;
3. Improved electrical conductivity of the phosphor screen because of the excellent electrical conductivity of the CNTs.

The following describes a method used to make a phosphor-CNT mixture prepared for display applications. The CNT and phosphor powders are mixed together in IPA (isopropyl alcohol) and deposited on a coating onto a substrate using an electrophoretic method. Other deposition methods such as spraying, screen printing, dispersing, dipping, brushing, ink jet printing, or spin-coating of the solution may also be used.

Source of Carbon Manotube and Phosphor Powder

Purified single wall carbon nanotubes (SWNTs) are available from many sources, such as Carbon Nanotechnologies, Inc., Houston, Tex. These SWNTs may be 1˜2 nm in diameter and 5˜20 pm in length. Other kinds of carbon nanotubes such as single wall, double-wall or multiwall carbon nanotubes (MWNTs) with different diameters and lengths from other venders may also be used with similar results.

Also, ZnS:Cu,Al green phosphor powders are used. The size of the powders may be less than 10 microns. Other kinds of phosphors, such as blue and red phosphor powders with different sizes, may also be used.

Solution for Electrophoretic Deposition Process

1) Grinding of SWNTs

CNTs can easily gather together and form as clusters and ropes. It is important to disperse them. A simple ball mill may be used to grind SWNT bundles. The rate of this machine is about 50˜60 revolutions per minute. In this method, 0.5 g (grams) SWNTs as well as tens of stainless steel balls used for grinding (5˜10 mm in diameter) are mixed with 100 ml IPA. The CNT powders may be ground for 1˜14 days in order to disperse the carbon nanotubes. A surfactant such as sodium dodecylbenzene sulfonate (see M. F. Islam, E. Rojas, D. M. Bergey, A. T. Johnson, and A. G. Yodh, Nano Lett. 3 (2), 269-273 (2003)) or similar materials may also be added to the mixture in order to achieve better dispersion of the carbon nanotubes. The solution may be further ultrasonicated by a horn head or bath before being mixed with the phosphor-IPA solution.

2) Preparation of Phosphor-CNT-IPA Solution

1 g phosphor powders are put in a beaker with 1 liter of IPA. The beaker is stirred using a stirring bar at the bottom of the beaker for 12 hours in order to disperse the powders. Then the CNT+IPA are added to the phosphor-IPA solution. Two different concentrations of the CNT were selected for a comparison: 1 wt. % CNT+99 wt. % ZnS:Cu,Al and 5 wt. %+95 wt. % ZnS:Cu,Al. Also, phosphor with no CNT was also made for the further comparison. After the CNTs were added into the beaker, the solution of the mixture may be further stirred for another 2 hours before the electrophoretic deposition process.

3) Deposition of the Phosphor-CNT Mixture Coating onto the Substrate

The phosphor-CNT mixture coating is deposited onto the substrate in this experiment by electrophoretic deposition. FIG. 1 shows a schematic diagram of the process.

The apparatus for the electrophoretic deposition vertically places a stainless steel anode plate 104 and a soda-lime glass cathode plate 106 coated by indium-tin oxide (ITO) in a beaker 102. The anode 104 and cathode 106 are placed parallel to each other at a distance of approximately 4 cm. The electrodes are connected to a 0-1000 volt DC supply 108. As mentioned above, for comparison, three solutions were made to deposit phosphor-CNT or phosphor coatings onto the ITO glass. The area of all the coatings was 2×2 cm². As a particle surface charge promoter, Mg(NO₃)₂-6H₂O may also be added in the solutions in order to improve the deposition rate. The concentration of the Mg(NO₃)₂-6H₂O may be on the order of 10⁻⁵ to 10⁻² moles/liter. The technique is much like a plating process, except particles are coated onto the surface instead of atoms of materials. An electrophoretic deposition technique is commonly used for depositing particles of phosphor onto conducting anode faceplates used in cathode ray tubes (televisions). The electrode may be metal or graphite, and ideally is a mesh or screen and not a solid sheet. The voltage between the anode and substrate is 200 V during the electrophoretic deposition process. For all the samples, the deposition time was 4 minutes. A thickness of around 10-15 microns of the coatings is obtained then. The solution is stirred constantly to uniformly disperse the phosphor particles 107 and CNT powders 108 in the solution 105. After deposition, the sample is removed from the beaker 102. The samples are dried in the air for 1 hour and immersed in 0.1 M potassium silicate solution for 10 minutes in order to improve the adhesion between the coating and the substrate. The samples are baked at 200° C. for 30 minutes and then cooled down to room temperature. These samples are then ready for brightness evaluation.

Luminance Test of the Samples

In order to test the luminance of all the samples, a CNT field emission cold cathode may be used. Under the certain electric field, electrons will be extracted from the CNT cold cathode and bombard the phosphor with a flood beam of electrons, generating a field emission image on the phosphor screen. A light meter (CS-100, Minolta Camera Co., LTD., Japan) may be used to test the luminance of the phosphor screen. The luminance of all the samples is tested at the same emission current.

1) Preparation of the CNT Cold Cathode

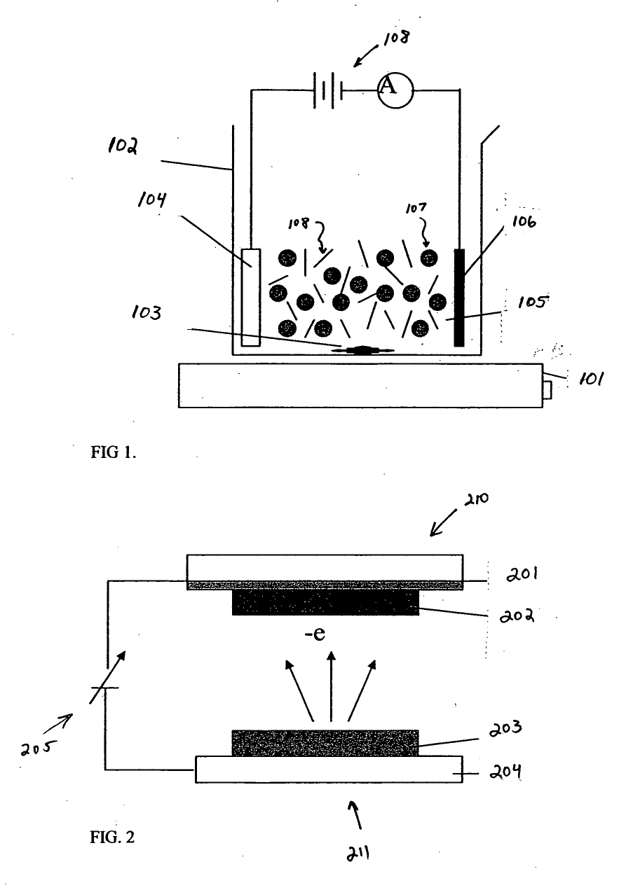

Referring to FIG. 2, the CNT cathode is prepared by spraying a CNT-IPA solution 203 on a silicon substrate 204 with an area of 2×2 cm² using an air-brusher. SWNTs made by Carbon Nanotechnologies, Inc. may be used. The silicon substrate 204 is sprayed back and forth and up and down several to tens of times until the mixture covers the surface. The thickness of the mixture may be about 5-10 μm. It is dried in air naturally.

2) Field Emission Test of the Samples

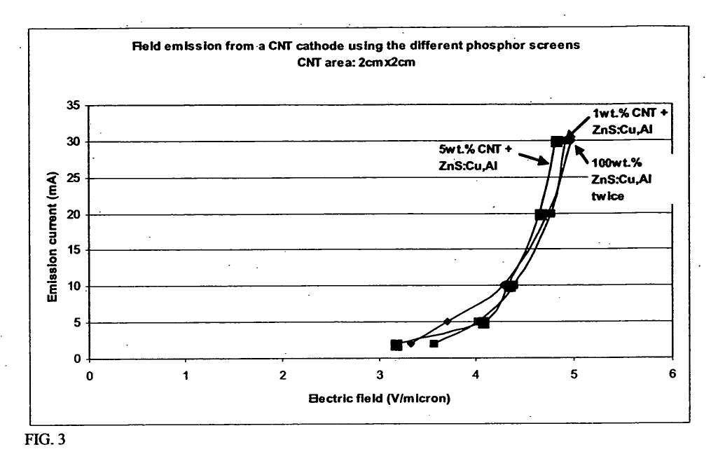

The phosphor samples are tested by mounting one of the samples with the same CNT cold cathode in a diode configuration with a gap of about 0.5 mm between the anode 210 and cathode 211. The test assembly was placed in a vacuum chamber and pumped to 10⁻⁷ Torr. The field emission of the cathode 211 is then measured by applying a negative, pulsed voltage (AC) 205 to the cathode 211 and holding the anode 210 at ground potential and measuring the current at the anode ITO 201. A DC potential could also be used for the testing, but this may damage the phosphor screen 202. A graph of the emission current vs. electric field for the samples is shown in FIG. 3.

It can be seen from FIG. 3 that the I-V curves are very close to each other. That means that the CNT cathode 211 did not have any degradation from changing the different phosphor screens 202.

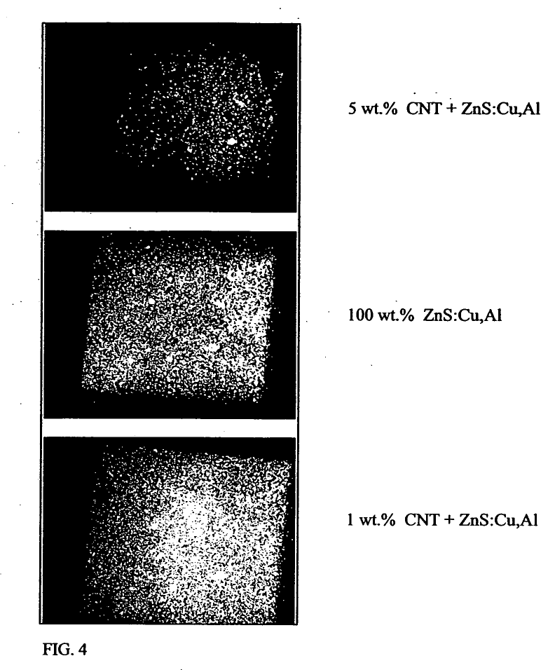

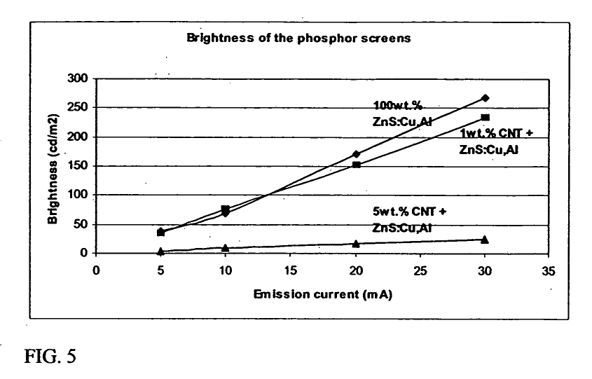

FIG. 4 shows digital images of the field emission images on the different phosphor screens at the same emission current (30 mA) of the CNT cathode 211. It can be seen that the phosphor screens with no CNT addition and with 1 wt. % CNT are much brighter than the phosphor containing 5 wt. % CNTs.

FIG. 5 illustrates a graph of the luminance (brightness) of the samples versus the current of the CNT cathode. It can be seen that the curves are very close between the phosphor (no CNT) and the phosphor-CNT (1 wt. %) samples. It means the addition of 1 wt. % CNT does not degrade the brightness of the phosphor. The phosphor-CNT(1 wt.%) sample has very good electrical conductivity. The phosphor-CNT (1 wt. %)-IPA solution was sprayed onto an insulating glass to make a 12 micron thick coating. A multimeter was used to test the electrical conductivity of the coating. It was tested with a resistance of 1,200 Ω with a distance of 1 cm between the two probes of the multimeter.

The color of the phosphor coating is also changed with the addition of the carbon nanotubes. With 1 % addition of SWNTs, the color is slightly darker. With 5 % addition of SWNT, the phosphor coating is considerably darker (a light charcoal color, gray). The color may be highly dependent on how dispersed the nanotubes are in the phosphor mixture and thus may be dependent on the process used. The darker color may be helpful to prevent reflection of ambient light on the phosphor faceplate and thus may improve contrast of the display in rooms with high ambient light levels or outdoor, daylight environments.

Various embodiments of the present invention having been thus described in detail by way of example, it will be apparent to those skilled in the art that variations and modifications may be made without departing from the invention. The invention includes all such variations and modifications as fall within the scope of the appended claims.

What is claimed is:

1. A phosphor comprising a mixture of phosphor powders and carbon nanotubes.

2. The phosphor as recited in claim 1, wherein the carbon nanotubes are single wall carbon nanotubes.

3. The phosphor as recited in claim 1, wherein the carbon nanotubes are multi-wall carbon nanotubes.

4. An anode comprising a substrate with a phosphor deposited thereon, wherein the phosphor further comprises a mixture of phosphor powders and carbon nanotubes.

5. The anode as recited in claim 4, wherein the carbon nanotubes are single wall carbon nanotubes.

6. The anode as recited in claim 4, wherein the carbon nanotubes are multi-wall carbon nanotubes.

7. The anode as recited in claim 4 wherein the substrate is transmissive to light.

8. A display comprising:
an electron emitter; and
an anode comprising a substrate with a phosphor deposited thereon, wherein the phosphor further comprises a mixture of phosphor powders and carbon nanotubes.

9. The display as recited in claim 8, wherein the carbon nanotubes are single wall carbon nanotubes.

10. The display as recited in claim 8, wherein the carbon nanotubes are multi-wall carbon nanotubes.

11. The display as recited in claim 8 wherein the substrate is transmissive to light.
